(19) United States
(12) Patent Application Publication
(10) Pub. No.: US 2012/0073412 A1
(43) Pub. Date: Mar. 29, 2012

(54) WEIGHT REDUCTION RE-PROFILING PROCESS AFTER DYNAMIC BALANCE FOR WHEEL SET OF PASSENGER TRAIN

(75) Inventor: XIAOYAN LIU, Jilin (CN)

(73) Assignee: CHANGCHUN RAILWAY VEHICLES CO., LTD., Jilin (CN)

(21) Appl. No.: 13/310,381

(22) Filed: Dec. 2, 2011

Related U.S. Application Data
(63) Continuation of application No. PCT/CN2010/074796, filed on Jun. 30, 2010.

(30) Foreign Application Priority Data
Nov. 20, 2009 (CN) 200910217882.6

(51) Int. Cl. B23B 1/00

(52) U.S. Cl. 82/1.11

(57) ABSTRACT

A weight reduction re-profiling process after dynamic balance for a wheel set of a passenger train, comprising the following steps: designing a spindle end clamp and a tailstock end clamp according to structures of screw holes on an end of train axle; fixing the spindle end clamp to the train axle; hanging up the wheel set, aligning a center hole of the spindle end clamp with a top tip of a spindle end of a lathe, and inserting a handle portion of the spindle end clamp into a drive plate hole; aligning an eccentric hole of the tailstock end clamp with a scribed line on an end for weight reduction after dynamic balance by visual inspection, then sheathing the tailstock end clamp on the train axle, aligning a top tip of tailstock of the lathe with the eccentric hole of the tailstock end clamp, and tightening them; and so on.

### CROSS-REFERENCE TO RELATED APPLICATIONS

This application is a continuation of International Application No. PCT/CN2010/074796 filed on Jun. 30, 2010, which claims the priority benefit of China Patent Application No. 200910217882.6, filed on Nov. 20, 2009. The contents of the above identified applications are incorporated herein by reference in their entirety.

### FIELD OF THE TECHNOLOGY

The present invention relates to a weight reduction re-profiling process after dynamic balance for a wheel set.

### BACKGROUND

At present, an undesirable weight increase method is used for re-profiling after dynamic balance detection for wheel set of a passenger train. The method comprises gluing a metal strip with a certain weight to the lighter side of the wheel set, and fastening the metal strip by a bolt. The operation of the vehicle reveals the fact that this method is very unreliable since the metal strip for re-profiling is basically lost after the vehicle runs for a period of time, and the running stability and comfortableness of the vehicle are affected.

### SUMMARY

The technical problem to be solved by the present invention is to provide a weight reduction re-profiling process which is suitable for all wheel sets of railway passenger trains with various rail gauges, and has good reliability, low operation cost, and high efficiency.

In order to solve the above technical problem, the present invention provides a weight reduction re-profiling process after dynamic balance for a wheel set of a passenger train, which comprising the following steps:

(1) designing a spindle end clamp and a tailstock end clamp according to structures of screw holes on an end of train axle;

(2) fixing the spindle end clamp to the train axle;

(3) hanging up the wheel set, aligning a center hole of the spindle end clamp with a top tip of a spindle end of a lathe, and inserting a handle portion of the spindle end clamp into a drive plate hole;

(4) aligning an eccentric hole of the tailstock end clamp with a scribed line on an end for weight reduction after dynamic balance by visual inspection, then sheathing the tailstock end clamp on the train axle, aligning a top tip of tailstock of the lathe with the eccentric hole of the tailstock end clamp, and tightening them;

(5) aligning a cutter with a weight reduction part, starting up the lathe, and accomplishing the weight reduction work according to a weight needed to be re-profiled; and

(6) starting a button to stop the running of the lathe, loosening the tailstock of the lathe after hanging up the wheel set by an overhead crane, and taking off the spindle end clamp and the tailstock end clamp one by one.

The present invention has a strong adaptability, and may be suitable for all wheel sets of railway passenger trains with various rail gauges. It also has low operation cost. The cutter cost of the present invention is only 10% of that of the dynamic balance numerical control weight reduction specialized machine. In addition, the present invention is high in efficiency and is suitable for spread procedure process.

### BRIEF DESCRIPTION OF THE DRAWINGS

FIG. 1 is a structural schematic view of the spindle end clamp according to the embodiment;

FIG. 2 is a cross-section view taken along line A-A of FIG. 1;

FIG. 3 is a structural schematic view of the tailstock end clamp according to the embodiment; and

FIG. 4 is a cross-section view of FIG. 3.

### DETAILED DESCRIPTION

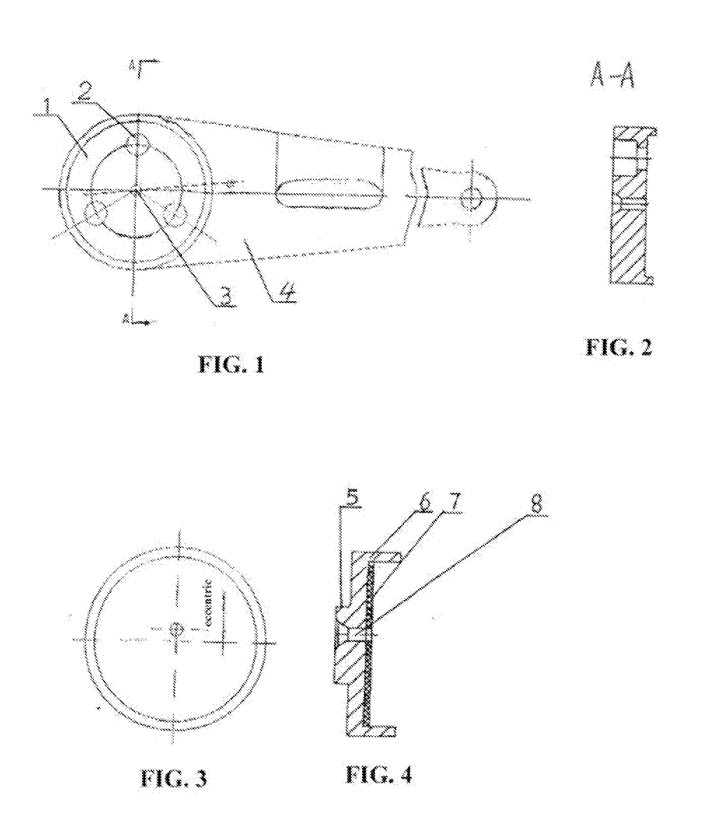

Referring to FIG. 1 and FIG. 2, a spindle end clamp comprises a head portion 1 and a handle portion 4 which are joined by welding. A center hole 3 is provided in the center of the head portion 1. A circular groove and three fixed holes 2 are machined on the upper surface of the head portion 1.

Referring to FIG. 3 and FIG. 4, a tailstock end clamp is a circular metal plate 6 which has a groove on one side and a boss 5 on the other side. A vulcanized rubber layer 7 is provided in the groove, and an eccentric hole 8 is machined on the tailstock end clamp.

The weight reduction re-profiling process comprises the following steps:

(1) designing the spindle end clamp and the tailstock end clamp according to structures of screw holes on an end of train axle;

(2) fastening the spindle end clamp to the train axle using three hexagon socket bolts, which correspond to the screw holes on the end of train axle, through the fixed holes 2;

(3) hanging up the wheel set using a overhead crane, aligning the center hole of the spindle end clamp to a top tip of a spindle end of a lathe, and inserting the handle portion of the spindle end clamp into a drive plate hole;

(4) aligning an eccentric hole of the tailstock end clamp with a scribed line on an end for weight reduction after dynamic balance by visual inspection, then sheathing the tailstock end clamp on the train axle by the groove of the tailstock end clamp, aligning a top tip of tailstock of the lathe with the eccentric hole of the tailstock end clamp, and tightening them;

(5) aligning a cutter to with a weight reduction part, starting up the lathe at a rotation speed of 10-15 r/min, manually feeding the cutter at a feed rate of 0.15 mm/r, and determining the cut weight of steel scraps according to a weight needed to be re-profiled till the weight reduction work is accomplished (a correct determination can be made usually after 5 left-right wheel sets are re-profiled), wherein the cutting re-profiling range is not more than 120 degrees, the depth is not more than 4 mm, and the roughness is in the range of Ra1.2.5 to 6.3; and the weight reduction work is accomplished according to the weight needed to be re-profiled; and

(6) starting a button to stop the running of the lathe, loosening the tailstock of the lathe after hanging up the wheel set by an overhead crane, and taking off the spindle end clamp and the tailstock end clamp one by one.

What is claimed is:

1. A weight reduction re-profiling process after dynamic balance for a wheel set of a passenger train, comprising the following steps:
(1) designing a spindle end clamp and a tailstock end clamp according to structures of screw holes on an end of train axle;
(2) fixing the spindle end clamp to the train axle;
(3) hanging up the wheel set, aligning a center hole of the spindle end clamp with a top tip of a spindle end of a lathe, and inserting a handle portion of the spindle end clamp into a drive plate hole;
(4) aligning an eccentric hole of the tailstock end clamp with a scribed line on an end for weight reduction after dynamic balance by visual inspection, then sheathing the tailstock end clamp on the train axle, aligning a top tip of tailstock of the lathe with the eccentric hole of the tailstock end clamp, and tightening them;
(5) aligning a cutter with a weight reduction part, starting up the lathe, and accomplishing the weight reduction work according to a weight needed to be re-profiled; and
(6) starting a button to stop the running of the lathe, loosening the tailstock of the lathe after hanging up the wheel set by an overhead crane, and taking off the spindle end clamp and the tailstock end clamp one by one.

2. The weight reduction re-profiling process according to claim 1, wherein the spindle end clamp further comprises a head portion, which has a center hole provided in the center thereof, and a circular groove and three fixed holes machined on the upper surface thereof.

3. The weight reduction re-profiling process according to claim 1, wherein the tailstock end clamp is a circular metal plate, which has a groove on one side and a boss on the other side, and wherein a vulcanized rubber layer is provided in the groove, and an eccentric hole is machined on the tailstock end clamp.
